(19) United States
(12) Patent Application Publication
(10) Pub. No.: US 2010/0256255 A1
(43) Pub. Date: Oct. 7, 2010

(54) JETTABLE INK COMPOSITION

(76) Inventor: Charles Stevens, Chapel Hill, NC (US)

Correspondence Address: PASSE' INTELLECTUAL PROPERTY, LLC, 1717 BRASSFIELD RD., RALEIGH, NC, 27614, US

(21) Appl. No.: 12/419,581

(22) Filed: Apr. 7, 2009

(51) Int. Cl. C08F 2/46

(52) U.S. Cl. 522/182

(57) ABSTRACT

Jettable radiation-curable building compositions and jettable support compositions useful for three-dimensional printing of objects, such as for rapid prototyping, which exhibit an excellent balance of liquid jettability properties and cured properties are provided. The radiation-curable building composition, which may be used for either three-dimensional printing or single pass (two-dimensional) printing comprises 10 to 30 percent of dendritic oligomer(s), 40-70 percent of mono-functional monomer(s), and up to 15 percent of at least one photoinitiator. The jettable support material has similar liquid jettability properties and a similar composition, but further comprises an amine synergist in an amount sufficient to produce a material that can be easily broken and separated from cured building material.

### COPYRIGHT NOTICE

A portion of the disclosure of this patent contains material that is subject to copyright protection. The copyright owner has no objection to the reproduction by anyone of the patent document or the patent disclosure as it appears in the Patent and Trademark Office patent files or records, but otherwise reserves all copyright rights whatsoever.

### FIELD OF THE INVENTION

The present invention relates to radiation curable compositions and methods suitable for three dimensional inkjet printing applications. In particular the present invention relates to compositions and methods of curable inks that obviate the need for surface agents such as a surfactant and show improved properties over compositions of the prior art.

### BACKGROUND OF THE INVENTION

There is a recognized need for radiation-curable jettable compositions, such as inks, that rapidly cure, exhibit excellent film durability and adhesion to substrates. Potential advantages include no volatile organic compound emissions or hazardous air pollutants, instant drying, high solvent resistance of the cured films, high light fastness of the cured films, lower energy requirement and space savings of curing equipment, and excellent storage stability. However, it is also recognized that there are challenges in achieving such radiation-curable, jettable compositions. In particular, there has been some difficulty in achieving liquid jettability properties such as low viscosity, low volatility, good droplet formation, formulation stability and rapid curing while also achieving the desired print and film properties after curing, such as scratch and/or abrasion resistance, good adhesion to substrates, hardness, and flexibility.

It has been proposed that improved radiation-curable ink compositions for ink-jet printing can be achieved by employing greater than 30 weight percent of a hyperbranched acrylate oligomer or a polyester tetraacrylate oligomer. Nevertheless, there remains a need for an improved radiation-curable, jettable composition exhibiting a better combination of liquid jettability properties and cured properties that facilitates lower temperature jetting of the composition and/or jetting from smaller diameter nozzles to facilitate higher resolution for two-dimensional printing and/or three-dimensional printing, such as for rapid prototyping.

### BRIEF SUMMARY OF THE INVENTION

The invention provides radiation-curable compositions having lower viscosity to facilitate jetting at lower temperatures, which in turn results in better ink stability, less energy use, faster start-up of equipment for jetting the ink on a substrate, and facilitates higher resolution printing making it possible to achieve precision printing and/or rapid prototyping at or near room temperature, generally without compromising desired properties of the cured films. The lower jetting temperatures that are possible with certain aspects of the invention, in addition to reducing energy demands, and facilitating faster start-up, reduce the potential for thermal damage, resulting in less wear and tear and longer useful lives of inkjet equipment. Another advantage of the lower compositions viscosity possible in accordance with certain aspects of the invention is that smaller size jetting nozzles may be employed to achieve higher printing resolution. It should also be noted that the present invention compositions exhibit improved pigment wetting and faster cure time when compared to the prior compositions for 3D curable polymers.

The radiation-curable, jettable compositions of the invention include 10-30 percent of at least one dendritic oligomer by weight, 20-70 percent of at least one mono-functional monomer by weight, up to 20 percent of at least one non-dendritic oligomer by weight, and up to 15 percent of at least one photoinitiator by weight. The radiation-curable, jettable compositions may optionally include up to about 20 percent by weight of poly-functional monomers, pigments, dispersion agents, anti-foaming agents, surfactants, biocides, humectants, buffering agents, and stabilizers. The dendritic oligomer or oligomers, mono-functional monomer or monomers, optional non-dendritic oligomer or oligomers, and the photoinitiator or photoinitiators comprise at least about 65 percent of the composition by weight.

The invention also relates to a similar composition that may be used as a support material for three-dimensional printing, such as for rapid prototyping. The support material may comprise up to 30 percent of at least one dendritic oligomer by weight, up to 30 percent of at least one mono-functional monomer by weight, and from 10 percent to 50 percent of a reactive amine synergist by weight. Reactive amines have been traditionally used for enhancing surface curing. However, it has been discovered that such reactive amines can act as plasticizers when used in larger quantities, and that this property may be exploited to produce a support material with weak physical properties that is strong enough to support the building material (radiation-curable, jettable composition) during rapid prototyping, but is capable of being easily removed after the desired three-dimensional object (model) has been completed.

These and other features, advantages, and objects of the present invention will be further understood and appreciated by those skilled in the art by reference to the following specification and claims.

### DETAILED DESCRIPTION OF PREFERRED EMBODIMENTS

Many inks with desirable properties are very high in viscosity and a tradeoff must be made to lower the viscosity in order to make them workable. Inkjet printing requires very low viscosity - so low that a great deal of monomer must be used, generally compromising the finished properties of the cured material. It would be desirable to use 100% epoxy or urethane oligomers. However, this would not be jettable with existing technology. This invention, with the right combination of raw materials, can actually provide a radiation-curable, jettable composition with extremely strong cured properties and very low viscosity before cure.

It would be desirable to provide print heads that would enable smaller nozzles and thus higher print resolution. This would not be possible with high viscosity inks using existing ink jet technology known to the art. Alternatively, one may lower the temperature of the jetting (because of the lowered viscosity) to enable printing at a lower temperature, thus, saving wear and tear, energy costs, risk of thermal polymerization of the ink in the printing heads and thereby increasing the safety of the printing process as well as the speed from turning the machine on until the time it actually prints (less time waiting for the heads to heat up if they only have to go to 40 C instead of 70 C). The compositions of this invention enable the above envisioned improvements that allow higher print resolution and/or lower jetting temperatures.

The low viscosity radiation-curable, jettable compositions of this invention may be used for two-dimensional printing, such as for banners, labels, and signage, or for three-dimensional printing, such as for rapid prototyping. It is conceivable that such compositions may be employed in other printing and/or coating applications, and may or may not contain colorants, such as dyes and/or pigments, depending on the particular application for which the composition is employed.

Radiation-curable, jettable compositions generally have a relatively low viscosity as compared with other ink compositions, such as those used for screen printing. The radiation-curable, jettable compositions of the invention typically have a dynamic viscosity at 20° C. that is in the range of 1 to 100 centipoise. Compositions used for inkjet printing typically have a surface tension of about 27-33 dynes/cm. In addition to these generally accepted requirements for inkjet printing compositions, it is highly desirable that such compositions are completely free of volatile organic components and hazardous air pollutants, cure very rapidly, and do not exhibit excessive shrinkage during curing (e.g., typically from 10 to 12%). Shrinkage is determined by dividing the difference between the density of the cured film and the applied liquid film by the density of the cured film, and multiplying by 100 to get the percent shrinkage. Other highly desirable properties include high solvent resistance, good adhesion to substrates, high flash points and excellent storage stability.

Radiation-curable, jettable compositions that meet or exceed all of the above-requirements may be formulated in accordance with the invention.

The radiation-curable compositions of the invention generally comprise from 10 to 30 percent of at least one dendritic oligomer by weight, and 20 to 70 percent of at least one mono-functional monomer by weight. Optionally, the radiation-curable compositions of this invention may comprise up to 20 percent of at least one non-dendritic oligomer by weight. These three types of ingredients (dendritic oligomers, non-dendritic oligomers, and mono-functional monomers) comprise at least 65 percent of the composition by weight. The composition also contains at least one photoinitiator with the remainder of the composition, if any, comprising poly-functional monomer(s), pigment(s), and/or dye(s), dispersion agent(s), anti-foaming agent(s), surfactant(s), biocide(s) (e.g., fungicide(s), bactericide(s), and algaecide(s)), humectants(s), buffering agent(s) and/or stabilizer(s). The photoinitiator(s) is (are) present in an amount that is effective to induce rapid curing of the composition upon exposure to an activating radiation.

By having a large proportion of the composition, i.e., at least 65 percent by weight comprised of dendritic oligomer(s), optional non-dendritic oligomers, and mono-functional monomer(s), it is possible to simultaneously achieve the required high functionality needed for fast curing, and the low viscosity needed for jetting the composition from the small diameter nozzles of inkjet print heads, while also being capable of achieving all or substantially all of the other desirable properties (e.g., no volatile organic compounds or hazardous air pollutants, and good adhesion to substrates).

Dendritic oligomers are highly branched macromolecules and are generally categorized based on the manner in which they are synthesized. Dendrimers generally are globular-shaped molecules prepared via a divergent or convergent iterative methodology in which a plurality of layers or generations are built on a preceding layer or generation in a stepwise process. At each step, the dendritic product is separated from any unreacted monomer, and in a next step the product is reacted with a different monomer having different functional groups. In divergent synthesis, the layers are synthesized from a core to a periphery, while in divergent synthesis, the layers are synthesized from an outer periphery inwardly toward a core. When synthesis conditions are carefully controlled, the resulting dendrimer is a perfectly regular mono-dispersed product. As a practical matter, macromolecules prepared using the above stepwise synthesis process are generally regarded as being dendrimers, even if there are some imperfections and a resulting polydispersity that is slightly greater than 1.

Hyperbranched oligomers and polymers have architectures similar to dendrimers and exhibit similar characteristics, such as high functionality and a generally globular shape. However, hyperbranched oligomers and polymers are generally synthesized via a one-pot reaction process, rather than an iterative process. As a result, hyperbranched oligomers and polymers generally have a polydispersity that is substantially greater than 1 (e.g., about 1.5 or more). Hyperbranched molecules can be distinguished from the more traditional types of branched molecules that were known prior to the development of dendrimers in the late 1980s and the synthesis of hyperbranched molecules in the 1990s. In general, hyperbranched molecules (oligomers and polymers) can be distinguished from non-dendritic branched molecules based on the degree of branching. The degree of branching (DB) has been defined as follows: DB=(branched units+terminal units)/(branched units+terminal units+linear units). Thus, a linear polymer, which does not have any branched units, only two terminal units, and a large number of linear units (e.g., monomer units), would have a degree of branching near zero. A perfect dendrimer has a degree of branching equal to 1. Generally, the more traditional types of branched polymers that were known prior to the development of dendritic molecules had a degree of branching that is significantly less than 0.2, whereas hyperbranched polymers generally have a degree of branching that is well in excess of 0.25, with about 0.5 being common, and there being at least one report of a one-pot synthesis (without multiple purification and reaction steps) of a polymer having a degree of branching of 1. See Gerhard Maier, Christina Zech, Brigette Voit, and Hartmut Komber, “An Approach to Hyperbranched Polymers with a Degree of Branching of 100%,” Macromolecular Chemistry and Physics, Vol. 199, Issue 12, pages 2655-2664 (1998).

Because there are various, and sometimes divergent, definitions for dendrimers and hyperbranched molecules, we will, unless otherwise indicated, define dendritic molecules to encompass oligomeric dendrimers, polymeric dendrimers, hyperbranched oligomers and hyperbranched polymers, with dendrimers being defined as molecules having a polydispersity of about 1 (e.g., from 1 to 1.1) and a degree of branching of about 1 (e.g., from 0.95 to 1), irrespective of how the molecule is synthesized, and hyperbranched molecules being defined as molecules having a polydispersity greater than 1.1 and a degree of branching of from 0.25 to slightly less than 0.95, irrespective of how the molecule is synthesized.

The terms “oligomer” and “oligomeric” generally refer to a plurality of monomeric units that have been chemically reacted and bonded together to form a molecule that is not large enough to be regarded as a polymer. Technical dictionaries sometimes define oligomers as “polymers having two, three or four monomers” or as consisting “of a finite number of monomer units.” A more meaningful definition should exclude dimers, trimers, and other low molecular weight molecules that exhibit properties more closely related to the monomers from which they are derived than to the high polymers formed by combining a large number of such monomers (e.g., about 100 or more), with the division between oligomer and polymer being the number of repeat units (e.g., monomers) at which there is not an appreciable or detectable change in properties (e.g., glass transition temperature) with the addition of another unit. While these definitions will not generally provide the same values for all monomeric materials used to form pre-oligomers (e.g., dimers, trimers, etc.), oligomers and polymers, and may not be precisely determinable even for a particular monomer, the range is typically from about 10 to about 30 or more repeat units. For purposes of this specification, the terms “oligomeric” and “oligomer” will, unless otherwise indicated, encompass molecules having from 10 to 40 repeating structural units or monomers, and will also encompass all materials specifically identified as hyperbranched oligomers.

Preferred hyperbranched oligomers that may be employed in the radiation curable, jettable compositions of this invention include acrylate and/or methacrylate functionalized hyperbranched oligomers (also referred to as hyperbranched or dendritic acrylate oligomers). A preferred class of dendritic acrylate oligomers is hyperbranched polyester acrylates (i.e., hyperbranched polyesters having reactive acrylate groups). Examples of hyperbranched polyester acrylates include those commercially available from Sartomer, Exton, Pa., under the designations CN2300, CN2301, CN2302, CN2303 and CN2304. Relevant properties for these hyperbranched polyester acrylates are listed in Table 1. Data for the conventional, non-dendritic poly-functional acrylate dipentaerythritol hexaacrylate (DPHA) is listed in Table 1 for comparison.

TABLE 1

| | | | | Surface |
|---|---|---|---|---|
| | | Acrylate | | Tension, |
| | | Equivalent | Viscosity @ | dynes/cm |
| Product | Acrylates/Molecule | Weight | 25 C., cPs | @25 C. |
| CN2300 | 8 | 163 | 600 | 32.6 |
| CN2301 | 9 | 153 | 3500 | 38.4 |
| CN2302 | 16 | 122 | 350 | 37.8 |
| CN2303 | 6 | 194 | 320 | 40.3 |
| CN2304 | 18 | 96 | 750 | 32.6 |
| DPHA | 6 | 102 | 13,000 | 39.9 |

Other hyperbranched oligomers that may be employed in the compositions of this invention include polyether methacrylates and/or acrylates, which can be prepared by acrylation (or methyacrylation) of a hydroxyl-functional hyperbranched polyether. For example, commercially available hyperbranched polyether polyols, such as Boltorn® H2O available from Perstorp, can be acrylated by reacting the polyether polyol with acrylic acid in the presence of a Broenstedt acid in accordance with known techniques. Another class of suitable hyperbranched oligomers is polyurethane (meth)acrylates, which can be prepared using (meth)acrylation techniques on hyperbranched polyurethanes.

The mono-functional monomers which may be employed individually or in combinations, include various compounds having a single reactive group, such as an acrylate or methacrylate group. The term “mono-functional monomer,” as used herein, refers to a free radical and/or ionically polymerizable material having a single reactive double bond. Examples of mono-functional acrylate monomers that may be employed in the compositions of this invention include acryloyl morpholine, octyl (meth)acrylate, nonylphenol ethoxylate(meth)acrylate, isonornyl(meth)acrylate, isobornyl(meth)acrylate, 2-(2-ethoxyethoxy)ethyl(meth)acrylate, 2-ethylhexyl(meth)acrylate, lauryl(meth)acrylate, beta-carboxyethyl(meth)acrylate, isobutyl(meth)acrylate, 2-hydroxyethyl(meth)acrylate, isodecyl(meth)acrylate, dodecyl(meth)acrylate, n-butyl(meth)acrylate, methyl(meth)acrylate, hexyl(meth)acrylate, (meth)acrylic acid, stearyl(meth)acrylate, hydroxyl-functional caprolactone ester(meth)acrylate, isooctyl(meth)acrylate, hydroxyethyl(meth)acrylate, hydroxymethyl(meth)acrylate, hydroxypropyl(meth)acrylate, hydroxyisopropyl(meth)acrylate, hydroxbutyl(meth)acrylate, hydroxyisobutyl(meth)acrylate, tetrahydrofurfuryl(meth)acrylate and isobornyl acrylate. A preferred mono-functional acrylate monomer is isobornyl acrylate.

The photointiators that may be employed individually or in combination include various compounds that form free radicals when irradiated, such as with ultraviolet light. Examples of such initiators include benzophenone; 1-hydroxycyclohexyl phenyl ketone; 2-benzyl-2-dimethylamino-(4-morpholinophenyl)butan-1-one; benzyl dimethylketal bis(2,6-dimethylbenzoyl)-2,4,4-trimethylphosphine oxide; 2-hydroxy-2-methyl-1-phenylpropanone; oligo(2-hydroxy-2-methyl-1-(4-(1-methylvinyl)phenyl)propane); 2,4,6-trimethylbenzophenone; 4-methylbenzophenone; 4-(2-hydroxyethoxy)phenyl-(2-hydroxy-2-propyl) ketone, available from Ciba Specialty Chemicals Pty Ltd under the name “Irgacure® 2959”; 2-methyl-1-[4-(methylthio)phenyl]-2-(4-morpholinyl)-1-propanone, available from Ciba Specialty Chemicals Pty Ltd under the name “Irgacure® 907”; and 2,4,6-trimethybenzoyl-diphenyl-phosphine oxide, available from Ciba Specialty Chemicals Pty Ltd under the name “Darocur® TPO.”

Other photoinitiators that may be employed include those that initiate polymerization by formation of ionic species, and photoinitiators that are activated by other than ultraviolet radiation, such as electronic beam.

The choice and amount of an initiator or a combination of initiators depends on several factors, as is known in the art, including the monomers, oligomers and other materials selected for a composition, the desired properties of the cured composition, the wavelength and intensity of the irradiating source, and the desired cure speed. For three-dimensional printing applications, such as for rapid prototyping, photoinitiators that achieve rapid cure rates and facilitate the formation of cured products from the selected reactants, and which exhibit an outstanding combination of desired properties, while also achieving significantly less yellowing include Irgacure® 907; Irgacure® 2959; Darocur® TPO; and Darocur® 819, which is comprised of bis(2,4,6-trimethylbenzoyl)phenylphosphine oxide. Typically, initiators are added in an amount of from about 0.5 percent to about 15 percent by weight of the composition.

In addition to the required reactive oligomers (10 to 30 percent by weight of the composition), the optional non-dendritic oligomers (up to 20 percent by weight of the composition) the mono-functional monomers (20 to 70 percent by weight of the composition), and the photoinitiators (an amount effective to induce a desirably rapid cure upon exposure to an activating radiation, and up to 15 percent by weight of the composition), the radiation curable, jettable compositions of the invention may optionally include other ingredients or additives in an amount that totals up to 20 percent of the composition by weight. Such optional ingredients include non-dendritic poly-functional monomers, such as diacrylates, triacrylates, etc.; pigments; dispersion agents; anti-foaming agents; surfactants; biocides, such as bactericides, algaecides and fungicides; humectants; buffering agents; and stabilizers.

Examples of non-dendritic poly-functional monomers that may be employed include: glycerol triacrylate, trimethylolpropane triacrylate, ethoxylated trimethylolpropane triacrylate, pentaerythritol triacrylate, pentaerythritol tetraacrylate, dimethylolpropane tetraacrylate, and dipentaerythritol pentaacrylate. Combinations of these poly-functional monomers and/or other poly-functional monomers may be included in the radiation-curable compositions of this invention.

In some cases, the combination of hyperbranched oligomers and mono-functional monomers result in a composition having a viscosity that is actually lower than desired for certain types of inkjet printing apparatuses. In such cases, the viscosity of the composition may be increased by adding at least one non-dendritic oligomer to the composition. The non-dendritic oligomers are typically linear or lightly-branched oligomers, but may be comprised of generally any oligomer that is not encompassed by the above definition of dendritic oligomers. Suitable non-dendritic oligomers that may be employed include linear and/or other non-dendritic analogues of the dendritic oligomers that are employed. Specific, non-limiting examples include non-dendritic polyester based urethane diacrylate oligomers that are commercially available from Sartomer under the designations CN965, CN962 and CN964. However, other types of compatible non-dendritic oligomers that provide the desired viscosity lowering effect without adversely affecting the properties (e.g., handling properties, stability, cure properties, physical properties of the cured composition, etc.) may be employed. When employed, the non-dendritic oligomers may comprise up to about 20 percent of the composition by weight. Non-dendritic oligomers also increase elongation to break and flexibility, in addition to reducing viscosity, and may be added for these purposes.

Pigments that may be optionally added to the radiation-curable compositions of this invention include organic pigments such as phthalocyanines, anthraquinones, perylenes, carbazoles, monoazo- and disazobenzimidazolones, isoindolinones, monoazonaphthols, diarylidepyrazolones, rhodamines, indigoids, quinacridones, diazopyranthrones, dinitranilines, pyrazolones, dianisidines, pyranthrones, tetrachloroisoindolinones, dioxazines, monoazoacrylides, anthrapyrimidines, and others known in the art.

Other pigments that can be employed are available commercially under the designation of Pigment Blue 1, Pigment Blue 15, Pigment Blue 15:1, Pigment Blue 15:2, Pigment Blue 15:3, Pigment Blue 15:4, Pigment Blue 15:6, Pigment Blue 16, Pigment Blue 24, and Pigment Blue 60; Pigment Brown 5, Pigment Brown 23, and Pigment Brown 25; Pigment Yellow 3, Pigment Yellow 14, Pigment Yellow 16, Pigment Yellow 17, Pigment Yellow 24, Pigment Yellow 65, Pigment Yellow 73, Pigment Yellow 74, Pigment Yellow 83, Pigment Yellow 95, Pigment Yellow 97, Pigment Yellow 108, Pigment Yellow 109, Pigment Yellow 110, Pigment Yellow 113, Pigment Yellow 128, Pigment Yellow 129, Pigment Yellow 138, Pigment Yellow 139, Pigment Yellow 150, Pigment Yellow 154, Pigment Yellow 156, and Pigment Yellow 175; Pigment Green 1, Pigment Green 7, Pigment Green 10, and Pigment Green 36; Pigment Orange 5, Pigment Orange 15, Pigment Orange 16, Pigment Orange 31, Pigment Orange 34, Pigment Orange 36, Pigment Orange 43, Pigment Orange 48, Pigment Orange 51, Pigment Orange 60, and Pigment Orange 61; Pigment Red 4, Pigment Red 5, Pigment Red 7, Pigment Red 9, Pigment Red 22, Pigment Red 23, Pigment Red 48, Pigment Red 48:2, Pigment Red 49, Pigment Red 112, Pigment Red 122, Pigment Red 123, Pigment Red 149, Pigment Red 166, Pigment Red 168, Pigment Red 170, Pigment Red 177, Pigment Red 179, Pigment Red 190, Pigment Red 202, Pigment Red 206, Pigment Red 207, and Pigment Red 224; Pigment Violet 19, Pigment Violet 23, Pigment Violet 37, Pigment Violet 32, Pigment Violet 42; and Pigment Black 6 or 7 (The Color Index, Vols. 1-8, by the Society of Dyers and Colourists, Yorkshire, England).

Solid pigments can be combined with one or more liquid materials. Optionally, a commercial pigment can be comminuted, for example by milling, to a desired size, followed by milling with one or more liquid ingredients. Generally, radiation-curable, jettable compositions should not contain particles having a size in excess of about one micrometer.

Additional ingredients such as flow additives, UV light stabilizers, hindered amine light stabilizers, emulsifiers and surfactants can also be employed and can be present in the compositions of the invention typically in an amount of up to 2 percent by weight.

For example, to enhance durability of a printed image graphic, especially in outdoor environments exposed to sunlight, a variety of commercially available stabilizing chemicals can be added to the ink composition. These stabilizers can be grouped into the following categories: heat stabilizers, ultra-violet light stabilizers, and free-radical scavengers. Heat stabilizers are commonly used to protect the resulting image graphic against the effects of heat and are commercially available under the trade designations MARK® V 1923 (Witco Corp. of Greenwich, Conn.); SYNPRON® 1163, Ferro 1237 and Ferro 1720 (Ferro Corp., Polymer Additives Div., Walton Hills, Ohio). Such heat stabilizers can be present in amounts ranging from about 0.02 to about 0.15 weight percent.

Ultraviolet light stabilizers are commercially available under the trade designations UVINOL® 400 (a benzophenone type UV-absorber sold by BASF Corp. of Parsippany, N.J.), Cyasorb UVI 164 from Cytec Industries, West Patterson, N.J., and TINUVIN® 900, TINUVIN® 123 and/or 1130 UV-absorber (Ciba Specialty Chemicals, Tarrytown, N.Y.) and can be present in amounts ranging from about 0.01 to about 5 weight percent of the total ink.

Free-radical scavengers can be present in an amount from about 0.05 to about 0.25 weight percent of the total ink. Nonlimiting examples of the scavenger include hindered amine light stabilizer (HALS) compounds, hydroxylamines, sterically hindered phenols, and the like.

Commercially available HALS compounds include TINUVIN® 292 (trade designation for a hindered amine light stabilizer sold by Ciba Specialty Chemicals, Tarrytown, N.Y.) and CYASORB® UV3581 (trade designation for a hindered amine light stabilizer sold by Cytec Industries, West Patterson, N.J.).

While stabilizers can be added in small amounts, it is preferred to use as little as possible (or none) to prevent interference with the reaction of the cure.

A wide variety of agents also can be used. Examples include aminobenzoates, secondary amines, silicones, waxes, morpholine adducts, amine materials available under trade designations Sartomer CN386 (a difunctional amine coinitiator, which when used in conjunction with a photosensitizer such as benzophenone, promotes rapid curing under UV light), CN381 (a copolymerizable amine acrylate that may be used as a synergist in combination with a suitable photoinitiator to increase cure speed, especially at the surface of a UV curable film), CN383 (an acrylated amine coinitiator, which when used in conjunction with a photosensitizer such as benzophenone, promotes rapid curing under UV light), and the like.

In addition, the radiation curable ink compositions of the invention can include other additives, such as, for instance, slip modifiers, thixotropic agents, foaming agents, antifoaming agents, flow or other rheology control agents, waxes, oils, plasticizers, binders, antioxidants, photoinitiator stabilizers, gloss agents, fungicides, bactericides, organic and/or inorganic filler particles, leveling agents, opacifiers, antistatic agents, dispersants and the like.

The invention also provides a building material that can be used in conjunction with the radiation-curable compositions for making three-dimensional objects, such as in three-dimensional modeling or rapid prototyping utilizing three-dimensional computer aided design data. In such three-dimensional printing, curable liquid material is dispensed and cured layer by layer to form a three-dimensional object. In accordance with this technique, the radiation-curable composition is used as a building material that is dispensed by a first inkjet head or set of inkjet heads, while a support material is simultaneously dispensed from a second inkjet head or set of inkjet heads. The support material is dispensed in locations where the building material is absent to hold the building material in place as the article is produced. At the conclusion of the model production, the support material is removed while the building material remains. There are many different techniques employed for removing the support material. For example, certain support materials can be liquefied by heating (e.g., waxes) to a temperature that is sufficiently low to prevent damage of the model that has been fabricated using the building material. As another example, certain support materials can be removed using pressurized water jet sprays. Ideally, support material exhibits jettability properties substantially the same as the radiation-curable, jettable composition used as a building material, while also exhibiting sufficient strength and toughness as a support material while allowing for easy removal from the finished model.

It has been discovered that reactive amines that have been conventionally used for enhancing surface cure can be used in larger quantities as a plasticizer, and this property can be exploited to produce a support material with weak physical properties, but which is strong enough to support the model during jetting, and is easily removed once the model is completed. Additionally, the support material of this invention has substantially the same liquid jettability properties as the radiation-curable compositions because the building materials and support materials of this invention have substantially the same components in substantially the same proportions, the most significant difference being that the support material includes a relatively high quantity of an amine synergist.

The support material of the invention comprises 1 to 30 percent, preferably from about 10 percent to 30 percent, of at least one dendritic oligomer by weight, 1 to 30 percent of at least one mono-functional monomer by weight, 10 to 50 percent of an amine synergist by weight, and optionally up to 15 percent of at least one photoinitiator by weight. As with the radiation-curable, jettable compositions that may be used as a building material, the support materials of this invention may comprise small amounts of other optional ingredients. Generally, the dendritic oligomers, mono-functional monomers, photoinitiators, and optional ingredients employed in the support material may be selected from the corresponding materials used in the radiation-curable, jettable building materials described above. As with the radiation-curable building materials, the support materials may comprise up to 20 percent by weight of poly-functional monomers, pigments, dispersion agents, anti-foaming agents, surfactants, biocides, humectants, buffering agents, and/or stabilizers.

Examples of amine synergists that may be employed include isopropylthioxanthone, ethyl-4-(dimenthylamino)benzoate, 2-ethylhexyldimethylaminobenzoate, and dimethylaminoethylmethacrylate. An example of a commercially available amine synergist that may be advantageously employed in the support material compositions of the invention include Sartomer® CN386, which is a di-functional amine co-initiator available from Sartomer Co., Inc., Exton, Pa.

By employing from about 10 percent to 50 percent of an amine synergist, the resulting composition, upon exposure to ultraviolet radiation, produces a material that becomes very rubbery and gel-like upon cure and breaks apart very easily, facilitating the creation of a support material that is easily separated from the building material at the completion of the model. In addition, support material is essentially completely miscible with the model material. It therefore seperates cleanly and without leaving a residue or imparting an opaque white residue or modified texture at the boundary line of the two materials due to effects of phase change, immiscibility and the like. The traditional support material is water soluble and the traditional model material is not, which generally makes them immiscible, forcing one to modify the model material in some way to make it miscible. This process can lead to less desirable (but miscible) compositions due to cost issues, more limited monomer selection, heath and safety effects and the like.

The invention will be further illustrated by exemplary formulations, which may be regarded as working examples, but which are not intended to limit the scope of the invention.

A first example of a radiation-curable, jettable composition that may be used for three-dimensional printing, such as for prototypes or models, has the following formula:

| INGREDIENT | AMOUNT |
|---|---|
| Hyperbranched polyester acrylate | 10 to 30 percent |
| oligomer-Sartomer ® CN2302 | |
| Reactive monomer-isobornyl | 40 to 70 percent |
| acrylate-Sartomer ® SR560 | |
| Photoinitiator-Ciba Irgacure ® 907 | 0 to 5 percent |
| Photoinitiator-Ciba Irgacure ® 2959 | 0 to 5 percent |
| Photoinitiator-Ciba Irgacure ® 819 | 0 to 2 percent |
| Slip agent-Byk Chemie Byk 307 | 0 to 1 percent |

Another example of a radiation-curable, jettable composition that may be used as a building material in accordance with the invention has the following formula:

| INGREDIENT | AMOUNT |
|---|---|
| Hyperbranched polyester acrylate | 10 to 30 percent |
| oligomer-Sartomer ® CN2302 | |
| Reactive monomer-isobornyl | 40 to 70 percent |
| acrylate-Sartomer ® SR560 | |
| Photoinitiator-Ciba Irgacure ® 907 | 0 to 5 percent |
| Photoinitiator-Ciba Irgacure ® 2959 | 0 to 5 percent |
| Photoinitiator-Ciba Darocur ® TPO | 0 to 5 percent |
| Slip agent-Byk Chemie Byk 307 | 0 to 1 percent |

An example of a support material in accordance with the invention has the following formulation:

| INGREDIENT | AMOUNT |
|---|---|
| Hyperbranched polyester acrylate | 1 to 30 percent |
| oligomer-Sartomer ® CN2302 | |
| Reactive monomer-isobornyl acrylate- | 1 to 30 percent |
| Sartomer ® SR560 | |
| Amine Synergist-Sartomer ® CN3861US | 10 to 50 percent |
| Photoinitiator-Ciba Irgacure ® 907 | 0 to 5 percent |
| Photoinitiator-Ciba Irgacure ® 2959 | 0 to 5 percent |
| Photoinitiator-Ciba Darocur ® TPO | 0 to 5 percent |
| Slip agent-Byk Chemie Byk 307 | 0 to 1 percent |

Compositions in accordance with certain aspects of the invention provide substantial benefits relating to the provision of a rapidly curable and radiation-curable composition that can be jetted from conventional inkjet nozzles at reduced temperature, and/or can be jetted from smaller nozzles to provide greater resolution. These benefits are derived from the lower viscosity that can be achieved with compositions in accordance with certain aspects of the invention. The lower viscosity can lead to shorter start-up times, reduced energy costs, and reduced wear and tear on printing equipment. Additionally, there is a flattened temperature versus viscosity curve for compositions in accordance with certain aspects of the invention, especially in the normal inkjetting temperature range, wherein the viscosity changes only very slightly with temperature as compared with conventional compositions. As a result, nozzle temperature does not need to be controlled as precisely as with conventional compositions. This, in turn, should facilitate the use of less expensive printing machines.

The above description is considered that of the preferred embodiments only. Modifications of the invention will occur to those skilled in the art and to those who make or use the invention. Therefore, it is understood that the embodiments shown in the drawings and described above are merely for illustrative purposes and not intended to limit the scope of the invention, which is defined by the following claims as interpreted according to the principles of patent law, including the doctrine of equivalents.

1. A radiation-curable, jettable composition for printing on a substrate and/or printing a three-dimensional article, the composition comprising:
a) 10-30 percent of at least one dendritic oligomer by weight;
b) 40-70 percent of at least one mono-functional monomer by weight;
c) an amount of at least one photoinitiator that is effective to induce rapid curing of the composition upon exposure to an activating radiation;
d) optionally up to 20 percent by weight of a non-dendritic oligomer by weight;
e) at least one dendritic oligomer, the optional at least one non-dendritic oligomer, and the at least one mono-functional monomer comprising at least 65 percent of the composition by weight;
f) optionally up to 20 percent by weight of additives selected from poly-functional monomers, pigments, dispersion agents, anti-foaming agents, emulsifiers, surfactants, biocides, humectants, buffering agents and stabilizers; and
g) wherein the composition does not contain a surface agent.

2. A composition of claim 1, wherein the mono-functional monomer is an acrylate.

3. A composition of claim 1, wherein the mono-functional monomer is isobornyl acrylate.

4. A composition of claim 1, wherein the dendritic oligomer is an acrylate oligomer.

5. A composition of claim 1, wherein the dendritic oligomer is a hyperbranched polyester acrylate.

6. A composition of claim 1, wherein the dendritic oligomer is a hyperbranched polyester acrylate having a weight average of from 6 to 18 acrylate groups per molecule.

7. A composition of claim 1, wherein the dendritic oligomer is a hyperbranched polyester acrylate having an acrylate equivalent weight of from 96 to 194.

8. A composition of claim 1, wherein the dendritic oligomer has a viscosity at 25° C. of from 320 to 3500 centipoise.

9. A jettable support material for three-dimensional printing of an article, the composition comprising:
a. 1 to 30 percent of at least one dendritic oligomer by weight;
b. 1 to 30 percent of at least one mono-functional monomer by weight;
c. 10 to 50 percent of an amine synergist by weight;
d. optionally up to about 15 percent of at least one photoinitiator by weight, optionally up to 20 percent by weight of a non-dendritic oligomer by weight; and
e. optionally up to 20 percent by weight of additives selected from poly-functional monomers, pigments, dispersion agents, anti-foaming agents, surfactants, biocides, humectants, buffering agents and stabilizers.

10. A composition of claim 9, wherein the mono-functional monomer is an acrylate.

11. A composition of claim 9, wherein the mono-functional monomer is isobornyl acrylate.

12. A composition of claim 9, wherein the dendritic oligomer is an acrylate oligomer.

13. A composition of claim 9, wherein the dendritic oligomer is a hyperbranched polyester acrylate.

14. A composition of claim 9, wherein the dendritic oligomer is a hyperbranched polyester acrylate having a weight average of from 6 to 18 acrylate groups per molecule.

15. A composition of claim 9, wherein the dendritic oligomer is a hyperbranched polyester acrylate having an acrylate equivalent weight of from 96 to 194.

16. A composition of claim 9, wherein the dendritic oligomer has a viscosity at 25° C. of from 320 to 3500 centipoise.
